(19) United States
(12) Patent Application Publication
(10) Pub. No.: US 2024/0056324 A1
(43) Pub. Date: Feb. 15, 2024

(54) Apparatus and Method for Setting Up Online Meeting Services

(71) Applicant: CANON U.S.A., INC., MELVILLE, NY (US)

(72) Inventors: Shingo Murata, Mineola, NY (US); Attaullah Samsul Seikh, Irvine, CA (US)

(21) Appl. No.: 18/448,576

(22) Filed: Aug. 11, 2023

Related U.S. Application Data
(60) Provisional application No. 63/371,421, filed on Aug. 15, 2022.

(51) Int. Cl. H04L 12/18; H04L 67/52; H04L 9/40; H04L 9/08

(52) U.S. Cl. CPC H04L 12/1818; H04L 67/52; H04L 63/0428; H04L 9/0861

(57) ABSTRACT

A server is provided and includes one or more processors and one or more memories storing instructions that, when executed, configures the one or more processors, to receive from a communication apparatus a request for activation of an online meeting service, provide, upon receiving the request for activation, a predetermined software program to another server such that the another server is able to provide a predetermined functionality regarding the online meeting service, obtain, from the another server, location information to be accessed to use the predetermined functionality regarding the online meeting service, and provide the location information to the communication apparatus.

### CROSS-REFERENCE TO RELATED APPLICATIONS

This application claims priority from U.S. Provisional Patent Application Ser. No. 63/371,421 filed on Aug. 15, 2022, the entirety of which is hereby incorporated by reference.

### FIELD

The present disclosure relates generally to setting up online meeting services.

### DESCRIPTION OF RELATED ART

Online meeting services such as Teams, Zoom, and Skype are known. Typically, users intended to use these online meeting services access a log-in page of which URL (Uniform Resource Locator) is publicly known and log-in based on a user account and password. However, it may be difficult to access and use an online meeting service if the URL or similar address information to access is not publicly known.

### SUMMARY

A server is provided and remedies the drawbacks described above. The server comprising one or more processors and one or more memories storing instructions that, when executed, configures the one or more processors, to receive from a communication apparatus a request for activation of an online meeting service, provide, upon receiving the request for activation, a predetermined software program to another server such that the another server is able to provide a predetermined functionality regarding the online meeting service, obtain, from the another server, location information to be accessed to use the predetermined functionality regarding the online meeting service, and provide the location information to the communication apparatus.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 is a block diagram of illustrating a system architecture of the present disclosure.

FIG. 2 is a block diagram of illustrating a system architecture regarding the meeting room X of the present disclosure.

FIG. 3 is a user interface of the present disclosure.

FIG. 4 is a sequence diagram of illustrating process of the present disclosure.

FIG. 5 is a sequence diagram of illustrating process of the present disclosure.

FIG. 6 is a block diagram detailing the hardware components of an apparatus that executes the algorithm according to the present disclosure.

### DETAILED DESCRIPTION

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples. Further, where more than one embodiment is described, each embodiment can be combined with one another unless explicitly stated otherwise. This includes the ability to substitute various steps and functionality between embodiments as one skilled in the art would see fit.

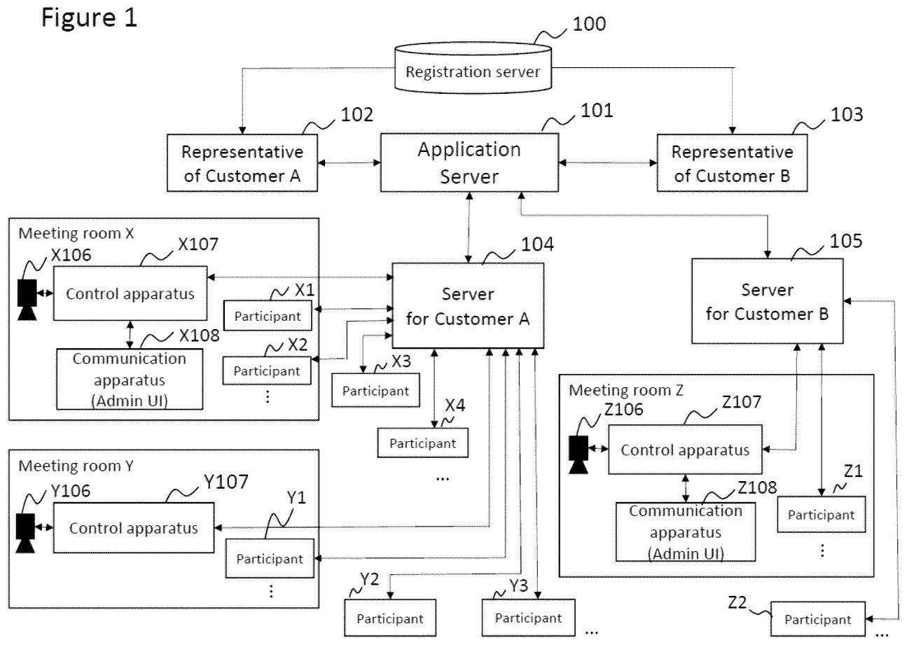

FIG. 1 illustrates a system architecture according to an exemplary embodiment. The system includes a registration server 100, an application server 101, a representative of customer A102 (hereinafter referred to as the representative A102), a representative of customer B103 (hereinafter referred to as the representative B103), a server for customer A104 (hereinafter referred to as the server A104), a server for customer B105 (hereinafter referred to as the server B105), cameras X106, Y106 and Z106, control apparatuses X107, Y107 and Z107, communication apparatuses X108 and Z108, participants X1-X4, Y1-Y3 and Z1-Z2. The representative A102, the representative B103, the control apparatuses X107, Y107 and Z107, the communication apparatus X108 and Z108, and the Participants X1-X4, Y1-Y3 and Z1-Z2 may be a laptop computer, a tablet computer, a smartphone or other type of computer, and each of the participants X1-X4, Y1-Y3 and Z1-Z2 may be operated by each of meeting attendees.

As shown in FIG. 1, each of the meeting rooms X, Y and Z has at least one camera 106 and the control apparatus 107. Also, the communication apparatus 108 is present in the meeting rooms X and Z. The communication apparatus 108 is used for remotely operating the control apparatus 107 to control an online meeting service. The meeting room Y is an example where an operator operates the control apparatus Y107 without using the communication apparatus 108. In this exemplary embodiment, the control apparatus Y107 has a mouse, a keyboard and/or a touch panel to be used to operate the control apparatus Y107. Note that FIG. 1 illustrates an example where the control apparatus 107 is present in each of the meeting rooms X, Y and Z. Alternatively, for example, the control apparatus X107 may be embodied as a control server that can remotely communicate with each meeting room (i.e. the cameras X106 and Y106 and the communication apparatus X108).

Also, one or more participants are present inside and outside each meeting room. For example, the participants X1 and X2 are present in the meeting room X and the participants X3 and X4 are outside the meeting room X. Typically, the participants X3 and X4 are located in another office than the meeting room X or located at home. In this exemplary embodiment, the participants X1 and X2 in the meeting room X and the participants X3 and X4 outside the meeting room X may be participating in the same online meeting X. However, no matter the location, any user logged into the online meeting is provided a graphical user interface of the same type, the display of which is selectively configurable by each individual participant. Thus, the functionality provided by a remote user interface is the same whether the remote user interface is being accessed from within the meeting room X or a location other than the meeting room X.

In this exemplary embodiment, the camera X106 may be a PTZ camera and takes a video in the meeting room X and provide the captured video to the control apparatus X107. The control apparatus X107 may be able to crop one or more specific regions (regions of presenter, participants and/or whiteboards) from the video, send each cropped video and the entire region of the video to the server 104, and/or detect hand gestures from the video to control the online meeting. In this exemplary embodiment, the control apparatus X107 may be able to send commands to the server A104 to control the online meeting service such as starting new online meeting, closing the online meeting, inviting other participants, identifying a region of interest in the meeting room X and/or taking a snapshot of a specific region in the meeting room X, based on a detected hand gesture or user operations on the control apparatus X107.

Similarly, the participant Y1 in the meeting room Y and the participants Y2 and Y3 outside the meeting room Y may be participating in the same online meeting Y and having the same capability and graphical user interface, and the participant Z1 in the meeting room Z and the participant Z2 outside the meeting room Z may be participating in the same online meeting Z and having the same capability and graphical user interface. In the exemplary embodiment, the camera Y106 and Z106 have the similar functionality with the camera X106, and the control apparatus Y107 and Z107 have the similar functionality with the control apparatus X107.

The server A104 is able to provide one or more online meeting functionalities and the control apparatus X107 and the control apparatus Y107 are able to request and control these online meeting functionalities in the server A104. The server B105 is able to provide the one or more online meeting functionalities and the control apparatus Z107 is able to request and control the online meeting functionalities in the server B105. In other words, the server providing online meeting functionalities may be different per Customer and each of the control apparatuses X107, Y107 and Z107 is required to identify and access the proper server which is appropriate to provide the online meeting functionalities.

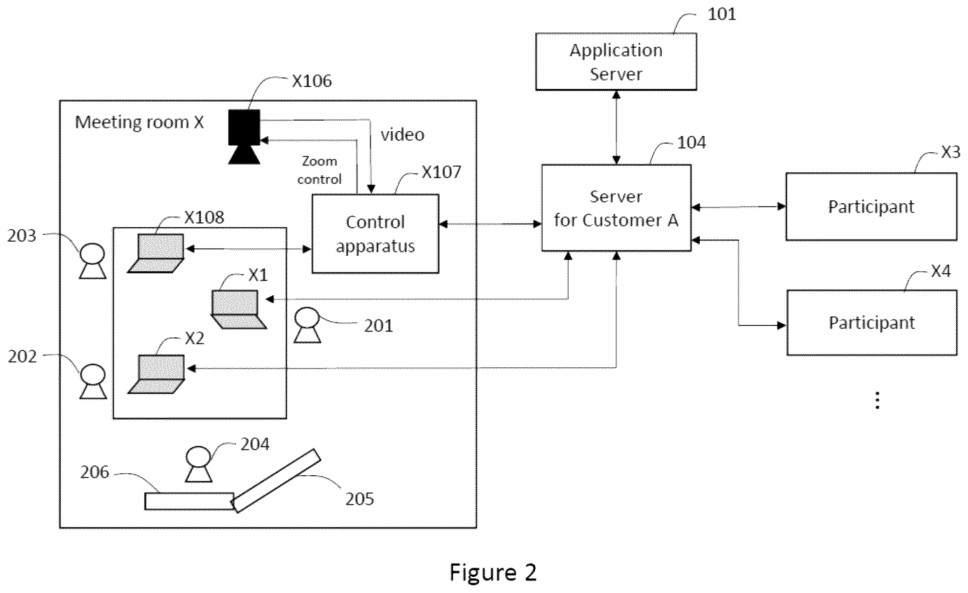

FIG. 2 illustrates a system architecture focused on the meeting room X. In this embodiment, the camera X106, the control apparatus X107, the communication apparatuses X108, the participants X1-X2, persons 201-203, a presenter 204 and whiteboards 205-206 may be present in the meeting room X and the participants X3-X4 are outside the meeting room X but all participants X1-X4 are participating in the same online meeting X. However, this is not seen to be limiting. For example, the control apparatus 103 can be located in the cloud and two or more cameras can be present in the meeting room X.

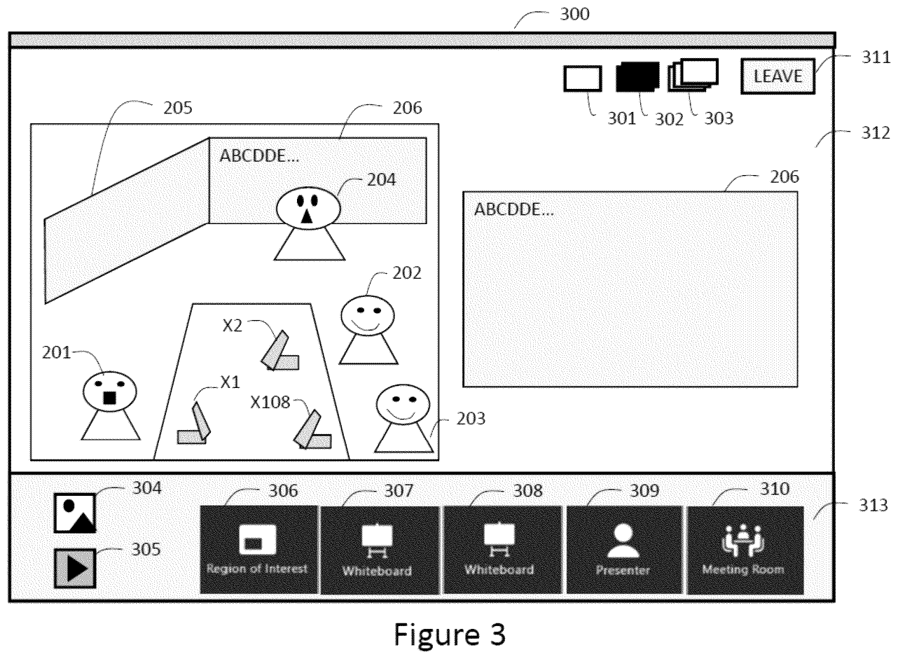

FIG. 3 illustrates the online meeting window 300 which may be displayed on each of the participants X1-X4 of an exemplary embodiment. As FIG. 3 illustrates, the online meeting window 300 contains a single view indicator 301, a two view indicator 302, a three view indicator 303, a still image button 304, a video button 305, video icons 306-310, and a leave button 311. The single view indicator 301, the two view indicator 302, the three view indicator 303 and the leave button 311 are located in the display region 312. The still image button 304, the video button 305, and the video icons 306-310 are located in a menu region 313.

When the two view indicator 302 is selected by a user, the online meeting window 300 displays two videos as shown in FIG. 3. In the present exemplary embodiment, if the single view indicator 301 is selected, only one video to display on the display region 312 may be selectable, and if the three view indicator 303 is selected, three videos to display on the display region 312 may be selectable. The user of each of the participants X1-X4 may choose any indicator from the indicators 301-303 to layout the online meeting window 300 and select one or more videos or still images to display on the display region 312. In this exemplary embodiment, the selection of the video may be conducted based on a drag-and-drop operation on the video icon (an ROI icon 306, a whiteboard icon A307, a whiteboard icon B308, a presenter icon 309 and a meeting room icon 310) from the menu region 313 to the display region 312. FIG. 3 illustrates an example where the Meeting room icon 310 and the whiteboard icon B308 have been selected, and the video of the entire meeting room X and the video of the whiteboard 206 are displayed on the display region 312 of the online meeting window 300.

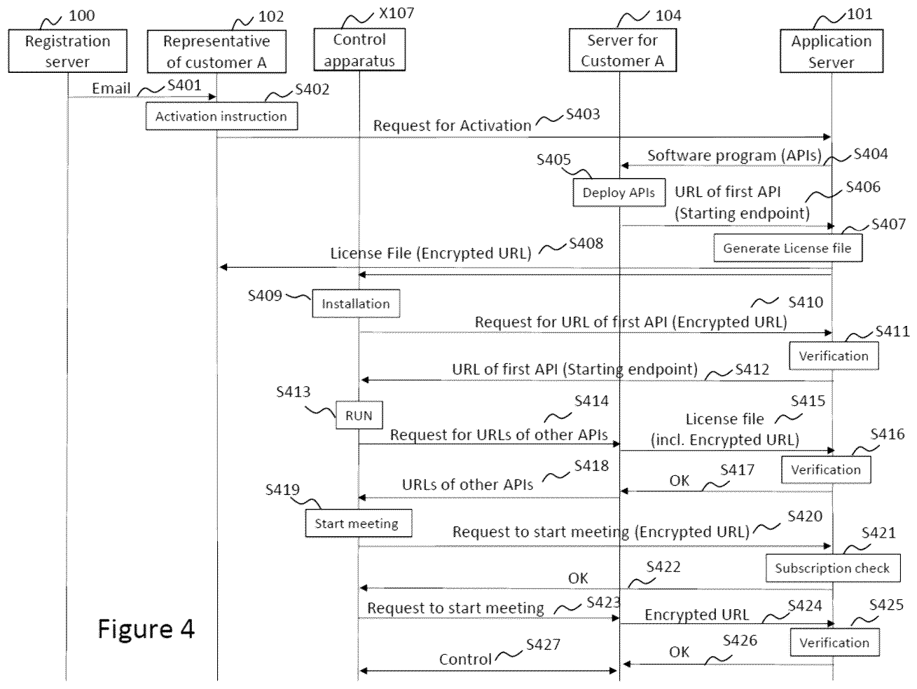

FIG. 4 is a sequence diagram illustrating communications between the registration server 100, the representative A102, the control apparatus X107, the server A104, and the application server 101 according to an exemplary embodiment. The communications of the exemplary embodiment will be described in detail below with reference to FIG. 4. In this embodiment, the process described with reference to FIG. 4 may be started in response to a trigger event where an operator (typically, a dealer or a sales person of the online meeting service) completes to register customer information to the registration server 100. The customer information may contain Customer Name (e.g. company name), Customer address (e.g. company location), Contact name (e.g. name of representative of the customer), Customer email address (e.g. email address of representative of the customer), Estimated purchase date and/or Estimated install date. After the registration, as shown in S401, an email is sent to the representative A102 to enable the customer to activate the online meeting service.

The representative A102 detects a user operation instructing activation in S402, the representative A102 sends a request for activation to the application server 101 in S403. In this exemplary embodiment, an operator may click or tap an activation button in the email sent in S401 to instruct the activation of the online meeting service. The activation button has a hyperlink to the application server 101 and the request for activation is sent to the application server 101.

When the application server 101 detects a user operation instructing the activation of the online meeting service, the application server 101 provides a predetermined software program to the server A104 in S404 such that the server A104 is able to provide a predetermined functionality regarding the online meeting service. In S405, the server A104 deploys multiple APIs (Application Programming Interfaces) in the server A104. The multiple APIs contain a first API for providing location information (e.g. URL) of the other APIs (e.g. a second API and a third API which are discussed later) regarding the online meeting service in response to a request from the control apparatus X107 or another apparatus. One example of the location information of this exemplary embodiment is a URL (Uniform Resource Locator). However, it's not seen to be limiting. Instead of URLs, directory and file name information may be used in a situation where, for example, the server name or IP address is already shared with the customer.

In S405, the server A104 obtains a plurality of pieces of location information corresponding to the multiple APIs which are deployed in the server A104. For example, in S405, the server A104 identifies the location information of the first API, the location information of a second API for starting and closing online meetings, the location information of a third API for distributing a video or a still image captured by the camera 106 to the meeting participants. In this exemplary embodiment, since the server A104 deploys the APIs including the first, second and third APIs in itself, the server A104 is able to identify/determine the URLs (location information) of these APIs.

In S406, the server A104 sends the location information of the first API to the application server 101. In this exemplary embodiment, the server A104 sends an un-encrypted URL of the first API to the application server 101.

In S407, the application server 101 generates a license file based on the location information (e.g. URL) of the first API. In this exemplary embodiment, the license file contains an encrypted location information of the first API. The application server 101 also generates a secret key used for decrypting the encrypted location information, and the application server 101 associates the un-encrypted location information, the encrypted location information, the secret key and the customer ID with each other and stores these information in a memory in S407. The un-encrypted location information and the secret key are used in the verification process by the application server 101 as discussed later, and in this exemplary embodiment, the license file does not contain these information.

In S408, the application server 101 sends the license file which contains the encrypted location information to the representative person. In this exemplary embodiment, the license file is attached to an email sent to the email address of the customer registered in the registration server 100. Thus, if the representative person uses the representative A102 to receive the email, the representative A102 is able to receive the encrypted location information from the application server 101, and if the representative person uses, instead of the representative A102, the control apparatus X107 or another apparatus to receive the email, such apparatus may be able to obtain the encrypted location information from the application server 101. Note that, instead of the email, the encrypted location information may be informed using file sharing services, text messages, voice messages, mailing services, facsimile or the similar methods.

In S409, the control apparatus X107 detects a user operation instructing installing an application software for the online meeting service. The application software may be used to send commands to the APIs in the server A104 to control an online meeting upon a user's operation. After installation, in S410, the control apparatus X107 sends a request for the location information of the first API. This request includes the encrypted location information of the first API. Since the control apparatus X107 does not have the secret key for decrypting the encrypted location information, the control apparatus X107 may need to request the un-encrypted location information to the application server 101.

In S411, the application server 101 verifies the encrypted location information and determines if the encrypted location information is the correct information. In the exemplary embodiment, the application server 101 decrypts the encrypted location information received from the control apparatus X107 using the secret key generated in S407, and the application server 101 compares the un-encrypted location information obtained in S407 with the decrypted location information obtained in S411. If these location information are identical, the application server 101 determines that the encrypted location information received from the control apparatus X107 in S410 is the correct information, and in S412, the application server 101 provides the un-encrypted location information to the control apparatus X107.

In the description above, S410 may be started in setup process for the online meeting service after the installation process of the application software. However, it's not seen to be limiting. For example, S410 may be performed during the installation process of the application software.

In S413, the control apparatus X107 detects a user operation to run the application software for the online meeting service, and in S414, the control apparatus X107 sends a request for the location information of other APIs (functionalities) for the online meeting service to the server A104. This request includes the encrypted location information of the first API. The server A104 forwards the encrypted location information to the application server 101 in S415.

In S416, the application server 101 verifies the encrypted location information and determines if the encrypted location information is the correct information. In the exemplary embodiment, the application server 101 decrypts the encrypted location information received from the control apparatus X107 using the secret key generated in S407, and the application server 101 compares the un-encrypted location information obtained in S407 with the decrypted location information obtained in S415. If these location information are identical, the application server 101 determines that the location information provided by the control apparatus X107 in S414 is the correct information, and in S417, the application server 101 permits the server A104 to provide the location information of the APIs to the control apparatus X107. In S418, the server A104 provides the un-encrypted location information of the APIs (e.g. the second API and the third API) to the control apparatus X107.

When the control apparatus X107 detects a user operation instructing starting an online meeting in S419, the process moves to S420. In S420, the control apparatus sends a request to start a new online meeting to the application server 101. This request includes the encrypted location information of the first API.

In S420, the application server 101 checks a subscription status of the customer A using the encrypted location information. If the application server 101 determines that the customer A is eligible to receive the online meeting service in S421, the application server 101 provides a permission to the control apparatus X107 in S422. More specifically, the application server 101 checks if the user account of the customer A is valid or suspended due to unpaid bills or other reasons to confirm the subscription status of the customer A in S421. However, instead of or in addition to checking the subscription status, the application server 101 may check if the number of meeting rooms in which the online meeting can occur simultaneously is exceeded the predetermined number, another online meeting is already active in the meeting room X, and/or some other factors to determine if the permission to start the meeting is able to be provided.

In S423, the control apparatus X107 send a request to start a new online meeting to the server A104. This request includes the encrypted location information of the first API. The server A104 forwards the encrypted location information to the application server 101 in S424.

In S425, the application server 101 verifies the encrypted location information and determines if the encrypted location information is the correct information. In the exemplary embodiment, the application server 101 decrypts the encrypted location information received from the control apparatus X107 using the secret key generated in S407, and the application server 101 compares the un-encrypted location information obtained in S407 with the decrypted location information obtained in S424. If these location information are identical, the application server 101 determines that the location information provided by the control apparatus X107 in S423 is the correct information, and in S426, the application server 101 permits the server A104 to start the new online meeting upon the request from the control apparatus X107. In S427, the server A104 starts the online meeting and provides the online meeting functionalities based on a user operation at the control apparatus X107. After starting the online meeting, when the control apparatus X107 detects an instruction to close the online meeting, the control apparatus X107 sends a termination request to the second API of the server A104, and the second API terminates the online meeting.

In the exemplary embodiment, the processes shown in S413-S418 may be performed only one time, and if the operator instructs to run the online meeting application software after completion of S413-S418, these processes may be skipped and wait for an instruction for starting the online meeting.

Note that FIG. 4 illustrates an example where the apparatus that detects the activation instruction in S402 and the apparatus that detects the installation instruction in S409 are the different apparatuses (the representative A102 and the control apparatus X107). However, it's not seen to be limiting. For example, the information for the activation instruction and the information for the installation instruction may be provided via emails sent to the registered email account, so the apparatus or apparatuses that detect such instructions are vary depending on which apparatus or apparatuses are used to receive each email by the person associated with the registered email account.

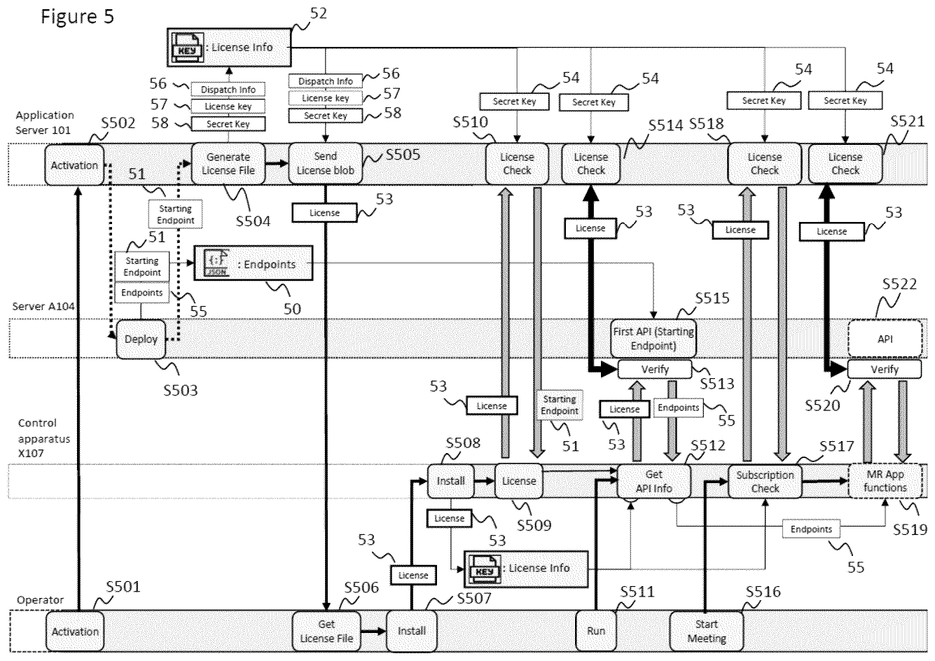

FIG. 5 illustrates communications between the application server 101, the server A104, the control apparatus X107, and the computer operated by an operator according to an exemplary embodiment. FIG. 5 is mainly different from FIG. 4 in illustrating about the user operations in one layer, as shown in the bottom of FIG. 5. Also, FIG. 5 provides detailed explanation about License information stored in the application server 101.

In S501, an operator having the email account of the representative of the customer A instructs the activation of the online meeting service, and the apparatus used by the operator detects this instruction and access the application server 101 for activation. In this exemplary embodiment, the email includes hyperlink to the application server 101 such that the activation request is sent to the application server 101 when the operator clicks or taps the activation button in the email. S501 is corresponding to S402 in FIG. 4.

In S502, the application server 101 provides software programs to the server A104, and in S503, the server A104 deploys APIs based on the software programs from the application server 101. In this exemplary embodiment, the APIs deployed in S503 contains the first API, the second API and the third API. The first API provides location information (e.g. URL) of other APIs (e.g. the second and third APIs) regarding the online meeting service in response to a request. The second API is used for starting and closing online meetings, and the third API is used for zoom control of the camera 106 in the meeting room X. However, the number of APIs and the functionalities are not seen to be limiting. The server A104 also obtains location information (e.g. URL) of each of the APIs in S503. The location information is stored in the memory which is accessible by the server A104 as shown as endpoints 50. The endpoints 50 contains Starting endpoint 51 (=location information of the first API) and the Endpoints 55 (=location information of the other APIs), and only starting endpoint 51 is provided to the application server 101 in S503. S502 is corresponding to S403 and S404 in FIG. 4, and S503 is corresponding to S405 and S406 in FIG. 4.

In S504, the application server 101 generates the license file 53 based on the Starting endpoint 51. In this exemplary embodiment, the license file 53 contains License key 57 which is the encrypted URL of the first API. In S504, the application server 101 stores Dispatch information 56 which is un-encrypted URL of the first API, License key 57 which is the encrypted URL of the first API and Secret key 58 which is used for decrypting the encrypted URL of the first API. S504 is corresponding to S407 in FIG. 4, and S505 is corresponding to S408 in FIG. 4.

After receiving the license file 53, the operator instructs to install the online meeting application software into the control apparatus X107. When the apparatus detects the instruction in S507, the install process using the license file 53 is started in S508. After the installation process, the control apparatus X107 sends the license file 53 which contains the encrypted location information of the first API to the application server 101, and the application server 101 starts the verification process in S510, as explained with referred to S411. If the application server 101 determines that the license file 53 is the correct information, then the application server 101 provides the starting endpoint 51 which is the un-encrypted location information (e.g. URL) of the first API deployed in the server A104.

When the operator instruction to run the installed online meeting application software is detected in S511, the control apparatus X107 sends the license file 53 to the server A104 to obtain the endpoints 55 which are un-encrypted location information of APIs (e.g. the second API and the third API) in S512. The control apparatus X107 is able to access the server A104 based on the location information of the first API (the starting endpoint 51) obtained in S509. The server A104 forwards the license file 53 to the application server 101 to have the application server 101 determines if the license file 53 is verified (S513 and S514). If the license file 53 is verified, the control apparatus X107 receives the endpoints 55 which are multiple of location information of APIs (e.g. the second and third APIs).

When the operator instruction to start an online meeting is detected in S516, the control apparatus X107 sends the license file 53 to the application server 101 for the subscription check process. The application server 101 checks a subscription status of the customer A using the encrypted location information in the license file 53. If the application server 101 determines that the customer A is eligible to receive the online meeting service in S518, the application server 101 provides a permission to the control apparatus X107 about starting the online meeting. This checking process is corresponding to S421 in FIG. 4.

After the subscription check process in S517, the control apparatus X107 accesses the first API and sends the license file 53 for the verification process. The server A104 forwards the license file 53 to the application server 101 and the application server 101 verifies the encrypted location information of the first API contained in the license file 53 in S521. After the verification process in S521, the control apparatus X107 is able to access to APIs deployed in the server A104 based on the endpoints 55 obtained in S512. In the exemplary embodiment, the processes shown in S512—S515 are performed only one time, and if the operator instructs to run the online meeting application software after completion of S512—S515, these processes may be skipped.

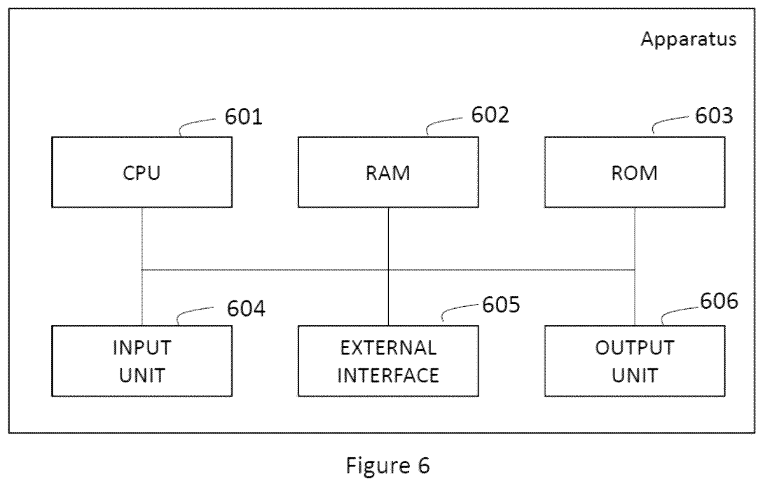

FIG. 6 illustrates the hardware that represents any of the registration server 100, the application server 101, the representative A102, the representative B103, the server A104, the server B105, the cameras X106, Y106 and Z106, the control apparatuses X107, Y107 and Z107, the communication apparatuses X108 and Z108, the participants X1-X4, Y1-Y3 and Z1-Z2. The apparatus includes a CPU 601, a RAM 602, a ROM 603, an input unit, an external interface, and an output unit. The CPU 601 controls the apparatus by using a computer program (one or more series of stored instructions executable by the CPU 601) and data stored in the RAM 602 or ROM 603. Here, the apparatus may include one or more dedicated hardware or a graphics processing unit (GPU), which is different from the CPU 601, and the GPU or the dedicated hardware may perform a part of the processes by the CPU 601. As an example of the dedicated hardware, there are an application specific integrated circuit (ASIC), a field-programmable gate array (FPGA), and a digital signal processor (DSP), and the like. The RAM 602 temporarily stores the computer program or data read from the ROM 603, data supplied from outside via the external interface, and the like. The ROM 603 stores the computer program and data which do not need to be modified and which can control the base operation of the apparatus. The input unit is composed of, for example, a joystick, a jog dial, a touch panel, a keyboard, a mouse, or the like, and receives user's operation, and inputs various instructions to the CPU 601. The external interface communicates with external device such as PC, smartphone, camera and the like. The communication with the external devices may be performed by wire using a local area network (LAN) cable, a serial digital interface (SDI) cable, WIFI connection or the like, or may be performed wirelessly via an antenna. The output unit is composed of, for example, a display unit such as a display and a sound output unit such as a speaker, and displays a graphical user interface (GUI) and outputs a guiding sound so that the user can operate the apparatus as needed.

The apparatus includes one or more modules that performs the functions described hereinabove. A module includes logic, computer-readable data, or computer-executable instructions. In the embodiment shown in FIG. 5, the modules are implemented in software (e.g., Assembly, C, C++, C#, Java, BASIC, Perl, Visual Basic, Python, Swift). However, in some embodiments, the modules are implemented in hardware (e.g., customized circuitry) or, alternatively, a combination of software and hardware. When the modules are implemented, at least in part, in software, then the software can be stored in the storage.

At least some of the above-described devices, systems, and methods can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Furthermore, some embodiments use one or more functional units to implement the above-described devices, systems, and methods. The functional units may be implemented in only hardware (e.g., customized circuitry) or in a combination of software and hardware (e.g., a microprocessor that executes software).

Additionally, some embodiments of the devices, systems, and methods combine features from two or more of the embodiments that are described herein. Also, as used herein, the conjunction “or” generally refers to an inclusive “or,” though “or” may refer to an exclusive “or” if expressly indicated or if the context indicates that the “or” must be an exclusive “or.”

While the present disclosure has been described with reference to exemplary embodiments, it is to be understood that the invention is not limited to the disclosed exemplary embodiments.

We claim:

1. A server comprising:
one or more processors; and
one or more memories storing instructions that, when executed, configures the one or more processors, to:
receive from a communication apparatus a request for activation of an online meeting service;
provide, upon receiving the request for activation, a predetermined software program to another server such that the another server is able to provide a predetermined functionality regarding the online meeting service;
obtain, from the another server, location information to be accessed to use the predetermined functionality regarding the online meeting service, and
provide the location information to the communication apparatus.

2. The server according to claim 1, wherein the instructions further configures the one or more processors to encrypt the location information,
wherein the encrypted location information is provided to the communication apparatus.

3. The server according to claim 2, wherein the instructions further configures the one or more processors to:
receive the encrypted location information from a control apparatus, and
provide, in response to the encrypted location information from the control apparatus, un-encrypted location information to the control apparatus thereby the control apparatus can access the predetermined functionality.

4. The server according to claim 3, wherein the instructions further configures the one or more processors to generate a secret key for verifying the encrypted location information, wherein the server provides the un-encrypted location information to the control apparatus when the encrypted location information is verified using the secret key.

5. The server according to claim 3, wherein the server receives the encrypted location information from the control apparatus during a setup process for an online meeting application software installed in the control apparatus.

6. The server according to claim 3, wherein the server receives the encrypted location information from the control apparatus during an installation process of an online meeting application software to the control apparatus.

7. The server according to claim 3, wherein the instructions further configures the one or more processors to:
receive an instruction to start an online meeting from the control apparatus; and
provide a permission to start the online meeting to the control apparatus when the encrypted location information included in the request is verified.

8. The server according to claim 1, wherein the location information is a URL (Uniform Resource Locator).

9. The server according to claim 2, wherein the instructions further configures the one or more processors to:
in response to a first request for the location information of the predetermined functionality from the control apparatus, provide un-encrypted location information of the predetermined functionality to the control apparatus, and
in response to a second request for another location information of one or more online meeting functionalities, control the another server to provide another un-encrypted location information of the one or more online meeting functionalities to the control apparatus,
wherein the first and second requests include the encrypted location information.

10. A communication method for a server of an online meeting, the method comprising:
receiving from a communication apparatus a request for activation of an online meeting service;
providing, upon receiving the request for activation, a predetermined software program to another server such that the another server is able to provide a predetermined functionality regarding the online meeting service;
obtaining, from the another server, location information to be accessed to use the predetermined functionality regarding the online meeting service, and
providing the location information to the communication apparatus.

11. A control apparatus comprising:
one or more processors; and
one or more memories storing instructions that, when executed, configures the one or more processors, to:
send a request for location information to be accessed to use one or more predetermined online meeting functionalities, wherein the request includes an encrypted location information representing a location to be accessed to use a predetermined functionality;
receive, as a response to the request, the location information of the one or more predetermined online meeting functionalities, and
control the one or more predetermined online meeting functionalities by accessing a location based on the location information.

12. A control method comprising:
sending a request for location information to be accessed to use one or more predetermined online meeting functionalities, wherein the request includes an encrypted location information representing a location to be accessed to use a predetermined functionality;
receiving, as a response to the request, the location information of the one or more predetermined online meeting functionalities, and
controlling the one or more predetermined online meeting functionalities by accessing a location based on the location information.
